(19) United States
(12) Patent Application Publication
(10) Pub. No.: US 2016/0110477 A1
(43) Pub. Date: Apr. 21, 2016

(54) MANAGING MULTIPLE RECORDS IN A WORKGROUP THROUGH SECONDARY NAVIGATION BUTTONS

(71) Applicant: ORACLE INTERNATIONAL CORPORATION, Redwood Shores, CA (US)

(72) Inventors: Jens O. LUNDELL, Santa Cruz, CA (US); Matthew J. WEST, Bozeman, MT (US); Jared BRATSKY, Bozeman, MT (US); Brad PASCOE, Bozeman, MT (US); William W. O'NEILL, Bozeman, MT (US)

(21) Appl. No.: 14/515,578

(22) Filed: Oct. 16, 2014

(51) Int. Cl. G06F 17/30; G06F 3/0484

(52) U.S. Cl. CPC G06F 17/30994; G06F 3/04842; G06F 3/04847

(57) ABSTRACT

Systems, methods, and other embodiments associated with providing efficient management of records of information associated with a computer application are described. In one embodiment, a record management tool is disclosed that dynamically generates workgroups of related records and allows easy and efficient navigation between the records in a workgroup via secondary navigation buttons provided as part of a graphical user interface. In response to user navigation between the records of a workgroup, a displayed editor is switched in a common editor space provided by the graphical user interface. The displayed editor corresponds to a presently selected secondary navigation button and associated record. Navigating between records and switching between editors may be accomplished without having to close any records of the workgroup.

### BACKGROUND

Computer software applications have become increasingly complex, not only from a processing level but also from a user interface level. With the increasing complexity, more and more attention is being paid to improving efficiencies associated with user interactions with the computer software applications. For example, in a customer support center for a company, an agent may use a computer software application running on a computer system to address and process complaints or questions submitted by customers in the form of incidents. When dealing with a particular incident, the agent may have to work through many records of information associated with the incident via a graphical user interface associated with the computer software application.

When a record is opened by the agent, information of the record is displayed in a window that pops up on a display screen via the graphical user interface. When multiple records are open, each record appears in a separate window, with the windows overlaying and blocking each other. This type of graphical user interface is difficult to navigate and makes it difficult for the agent to work with the multiple records.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a computer system, having a computing device configured with a record management tool;

FIG. 2A illustrates one embodiment of a display view of a graphical user interface provided by a graphical user interface logic of the record management tool of FIG. 1;

FIG. 2B illustrates one embodiment of a partial display view associated with the graphical user interface of FIG. 2A and showing the opening of a related record of a workgroup;

FIG. 3A illustrates another embodiment of a display view of a graphical user interface provided by the record management tool of the computer system of FIG. 1;

FIG. 3B illustrates a portion of the embodiment of the display view of FIG. 3A associated with saving multiple related records via a single user interaction with a graphical user interface;

FIG. 4 illustrates one embodiment of a computer-implemented method, performed by the record management tool of the computer system of FIG. 1, for working with a plurality of related records;

FIG. 5 illustrates one embodiment of a display view of a graphical user interface showing a plurality of secondary navigation buttons representative of related records in a workgroup;

FIG. 6 illustrates another embodiment of a display view of a graphical user interface provided by the record management tool of the computer system of FIG. 1;

FIG. 7 illustrates another embodiment of a display view of a graphical user interface provided by the record management tool of the computer system of FIG. 1;

FIG. 8 illustrates another embodiment of a display view of a graphical user interface provided by the record management tool of the computer system of FIG. 1;

FIG. 9 illustrates an embodiment of a first updated view of the display view of FIG. 6.

FIG. 10 illustrates an embodiment of a second updated view of the display view of FIG. 6;

FIG. 11A illustrates an embodiment of an updated view of the display view of FIG. 7;

FIG. 11B illustrates a portion of the embodiment of the display view of FIG. 10 associated with saving multiple related records via a single user interaction with a graphical user interface; and

FIG. 12 illustrates one example embodiment of a computing device upon which the record management tool of the computing system of FIG. 1 may be implemented.

### DETAILED DESCRIPTION

Systems and methods are described herein of a computer system and/or application that provide efficient management of records of information via a graphical user interface. In one embodiment, a record management tool is disclosed that dynamically generates workgroups of related records and allows improved and efficient navigation between the records in a workgroup via secondary navigation buttons provided as part of the graphical user interface.

In one embodiment, the graphical user interface is configured to organize and display multiple opened records in a display editor. The display editor is configured as a common editor space that is shared by the records on a display. Secondary navigation buttons are generated and displayed where each button is configured to provide access to one of the opened records. In response to user navigation between the records of a workgroup, the record information in the displayed editor is switched to the selected record. The displayed editor corresponds to a presently selected secondary navigation button and associated record. Navigating between records and switching between associated editors may be accomplished without having to close any of the records of the workgroup. As a result, the record management tool provides efficient manipulation and updating of multiple records of information in a dynamically defined workgroup.

Example embodiments are discussed herein with respect to a customer support system configured to create and manage records for a customer support center, where complaints or questions submitted by customers in the form of incidents are handled. Related records associated with an incident in a customer support center scenario may include, for example, a contact record, a task record, an opportunity record, an organization record, and an asset record. Other types of related records are possible as well, in accordance with other embodiments. Furthermore, other embodiments may be implemented as part of any computer application for manipulating multiple records of information using a graphical user interface.

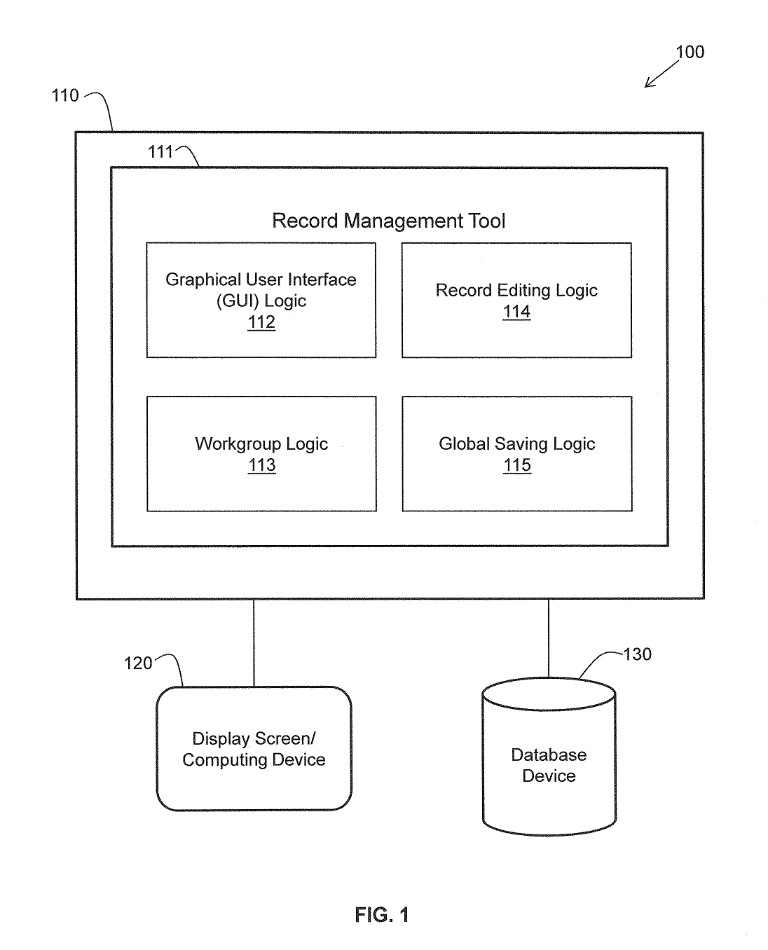

FIG. 1 illustrates one embodiment of a computer system 100, having a computing device 110 that is configured to provide management of data records for an organization. For example, in accordance with one embodiment, a record management tool 111 may be a customer service computer application of a company, configured for handling customer incidents (e.g., complaints and questions) associated with a service or product. In accordance with one embodiment, a graphical user interface is provided by a graphical user interface logic of the customer service computer application. In one embodiment, the application may be customer relationship management software for enterprise organizations. The software and computing device 110 may be configured to operate with or be implemented as a cloud-based networking system, a software as a service (SaaS) architecture, or other type of computing solution.

With reference to FIG. 1, in one embodiment, the record management tool 111 is implemented on the computing device 110 and includes a plurality of logics for implementing various functional aspects of the record management tool 111. In one embodiment, the record management tool 111 includes a graphical user interface (GUI) logic 112, a workgroup logic 113, a record editing logic 114, and a global saving logic 115. However, other embodiments may provide different logics or combinations of logics that provide the same or similar functionality as the record management tool 111 of FIG. 1. In one embodiment, the record management tool 111 is an executable application including algorithms and/or program modules configured to perform the functions of the logics. The application is stored in a non-transitory medium.

The computer system 100 also includes a display screen 120 operably connected to the computing device 110. In accordance with one embodiment, the display screen 120 is used to display views of a graphical user interface (GUI) provided by the GUI logic 112 for record management. In one embodiment, the record management tool 111 is a centralized server-side application that is accessed by many users. Thus the display screen 120 may represent multiple computing devices/terminals that allow users to access and receive services from the record management tool 111 via network communications. The computer system 100 further includes at least one database device 130 operably connected to the computing device 110 or a network interface to access the database device 130 via a network connection. In accordance with one embodiment, the database device 130 is configured to store and manage data records associated with the record management tool 111 (e.g., a customer service computer application) in a database system.

Referring back to the logics of the record management tool 111 of FIG. 1, in one embodiment, the GUI logic 112 is configured to at least provide a graphical user interface. For example, the GUI logic 112 includes program code that generates and causes the graphical user interface to be displayed based on implemented graphical design of the interface. The GUI logic 112 is also configured to facilitate the opening of records associated with the record management tool (e.g., a customer service computer application) on a display screen in response to user interaction with the graphical user interface. For example, in response to user actions and selections via the GUI, associated data records may be generated, accessed, edited, or otherwise manipulated via the database. The GUI logic 112 is also configured to facilitate generating and displaying, on a display screen, of secondary navigation buttons associated with the records upon opening of the records via the graphical user interface.

As an example, the graphical user interface provided by the GUI logic 112 is configured to allow a user (e.g., an agent of a customer support center) to create, access, open, view, edit, and delete records stored in the database device 130. Various examples of the interface will be discussed in the following figures as well as examples of the secondary navigation buttons and their functionality.

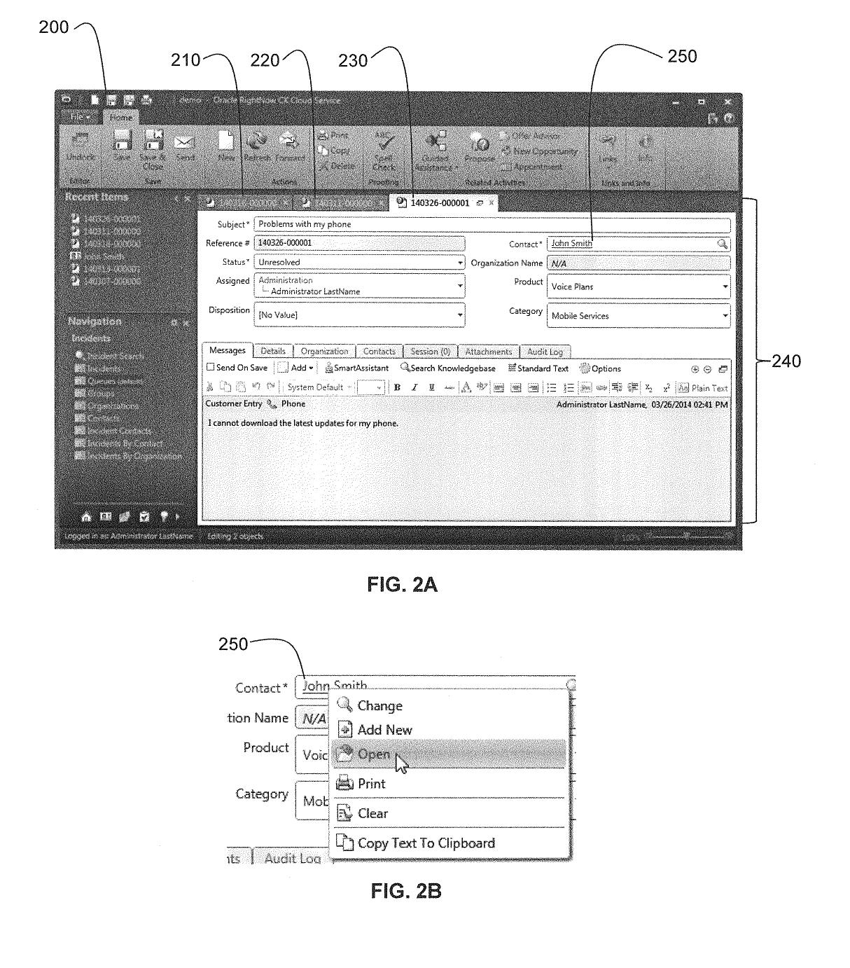

FIG. 2A illustrates one embodiment of a display view 200 of a graphical user interface provided by the graphical user interface logic 112 of the record management tool 111. The display view 200 shows three tabs 210, 220, and 230 representing three different records of incidents reported by three different customers to a customer support center. The three records of incidents may have been accessed from the database device 130, for example.

The third incident record (as represented by tab 230) is shown as being currently selected and, accordingly, an editor associated with the third incident record is displayed in a common editor space 240 of the display view 200. The editor displayed in the common editor space 240 includes various fields of information, some of which represent records of information that are related to the third incident record represented by the tab 230. In accordance with one embodiment, a user may select and open, via the graphical user interface, one or more of the various related records displayed in the common editor space 240, creating a workgroup of related records.

FIG. 2B illustrates one embodiment of a partial display view associated with the graphical user interface of FIG. 2A and showing the opening of a related record of a workgroup. Upon opening a related record (e.g., opening contact record 250 as shown in FIG. 2B), a representation of the opened record may be displayed as a secondary navigation button in the graphical user interface displayed on the display screen 120. As elaborated on later herein, a user may navigate between the various opened records by selecting (e.g., clicking on) various associated secondary navigation buttons. The secondary navigation buttons are referred to herein as “secondary” because they are associated with records that are secondary to or subordinate to a primary record.

A primary record is a higher level record (e.g., an incident record) in a hierarchical structure of records corresponding to, for example, an incident submitted by a customer. A secondary or subordinate record is a child record at a lower level in the hierarchical structure that relates back to, either directly or indirectly, the primary record. For example, a secondary record may correspond to a contact information record 250 of the customer, relating directly back to the primary or parent incident record represented by tab 230. The secondary navigation buttons facilitate easy navigation between editors of the records of a workgroup in the common editor space 240, avoiding undesirable issues such as multiple overlaid windows.

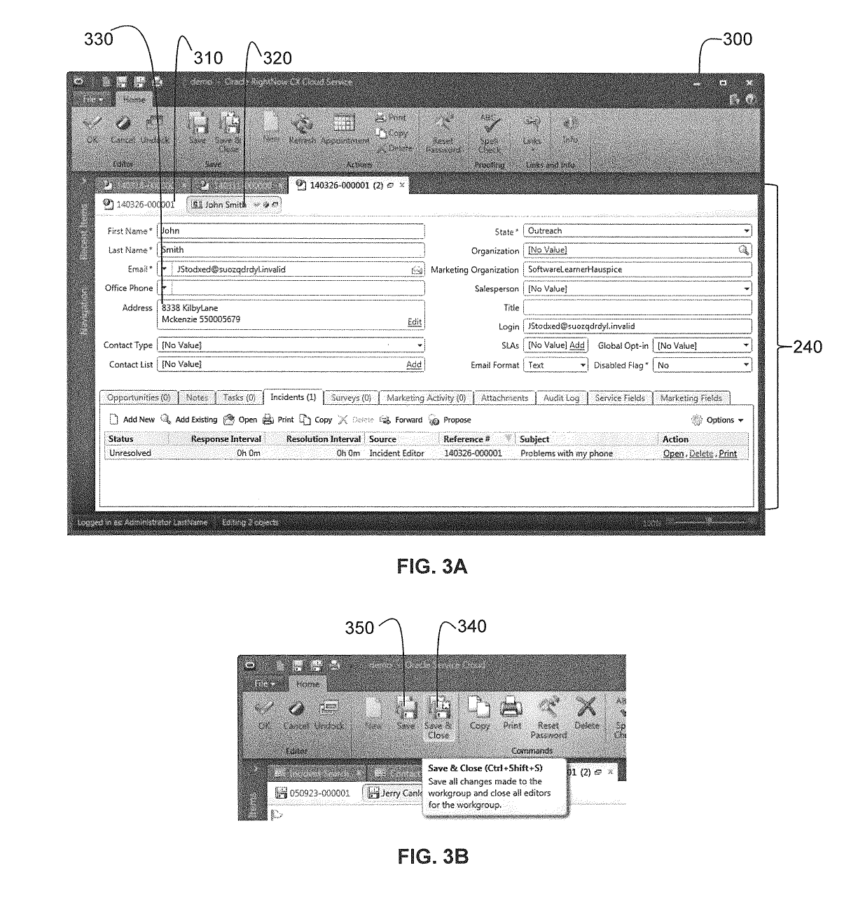

FIG. 3A illustrates another embodiment of a display view 300 of the graphical user interface provided by the graphical user interface logic 112 of the record management tool 111. The display view 300 shows that the contact record 250, for John Smith, has been opened (e.g., via the user menu selection action illustrated in FIG. 2B). As seen in FIG. 3A, the editor (for the third incident record associated with the tab 230) in the common editor space 240 has been replaced by the editor for the contact record 250. Furthermore, the third incident record (i.e., the parent incident record) associated with the tab 230 and the related contact record 250 are represented as secondary navigation buttons 310 and 320, respectively, in proximate location to each other in the common editor space 240. The secondary navigation buttons 310 and 320 allow navigation between the incident record and the contact record as discussed below herein.

Referring again to the logics of the record management tool 111 of FIG. 1, the workgroup logic 113 is configured to dynamically generate a workgroup comprising a plurality of related records associated with the record management tool 111. The workgroup is generated in response to the graphical user interface logic 112 opening the plurality of related records in response to user interaction with the graphical user interface. The workgroup logic 113 is also configured to allow user navigation between the plurality of related records of the workgroup via user selection of the secondary navigation buttons. The workgroup logic 113 is further configured to switch a displayed editor, in a common editor space 240 provided by the graphical user interface logic 112, to correspond to a presently selected secondary navigation button and associated record.

The workgroup is generated dynamically in the sense that, as the user opens related records, those records are added to the workgroup. For example, a user may open a contact record, an organization record, and a task record which are related under a primary incident record. The workgroup logic 113 generates a workgroup having the related open records as members of the workgroup and allows the user to freely navigate back and forth between the incident record, the contact record, the organization record, and the task record in any order.

Record information of a record is displayed on the display screen 120 by the graphical user interface logic 112 as an editor in the common editor space 240. In accordance with one embodiment, each record has its own editor. Each editor contains fields of record information for that record which may be displayed and edited. As a user navigates between the records of a workgroup via user selection of the secondary navigation buttons, the editor for a newly selected record is switched into the common editor space, replacing the editor for the previously selected record.

In one embodiment, the common editor space 240 provided on the display screen 120 by the graphical user interface logic 112 is a same, single common editor space. A new editor space is not created by the graphical user interface logic 112 when navigating to a different record of the workgroup.

Instead, upon navigating to a different record of the workgroup, the editor currently being displayed in the common editor space 240 is replaced by the editor for the different record that is selected. In this way, there are not multiple editor spaces with different editors being displayed at the same time, cluttering the display screen 120.

Referring again to the logics of the record management tool 111 of FIG. 1, the record editing logic 114 is configured to provide an editor for each related record in a workgroup. The record editing logic 114 facilitates editing of the records in the workgroup in the same common editor space 240. Editing of a record may be accomplished by, for example, deleting information, adding information, and copying and pasting information. Other means of editing a record may be possible as well, in accordance with other embodiments.

For example, referring to FIG. 3A, the information in the address field 330 of the contact record 250 for John Smith may be edited (e.g., if John Smith's address has changed). As discussed above, the workgroup logic 113 switches the editor displayed in the common editor space as a user navigates between records via the secondary navigation buttons.

The global saving logic 115 is configured to save all edited changes to the related records in a workgroup to the database device 130 in response to a single user interaction (e.g., via one computer mouse click) with the graphical user interface. Edited changes to individual records do not have to be individually saved, and one record in the workgroup does not have to be closed before saving the edited changes of another record in the workgroup. FIG. 3B illustrates a portion of the embodiment of the display view 300 of FIG. 3A associated with saving multiple related records via a single user interaction with the graphical user interface.

For example, referring to FIG. 3B, by clicking on the “save and close” icon 340, all edited changes in the editor of the primary incident record associated with tab 230 and all edited changes in the editor of the contact record 250 will be saved to the database device 130. Furthermore, all of the records in the workgroup will be closed. If the user, instead, clicked on the “save” icon 350, all of the edited changes would be saved, however, the records would not be closed. In one embodiment, the “save” and “save and close” icons are represented as multiple overlaid icons to indicate that multiple records are being saved. In this manner, a record management tool can provide efficient manipulation and updating of multiple records of information in a dynamically defined workgroup.

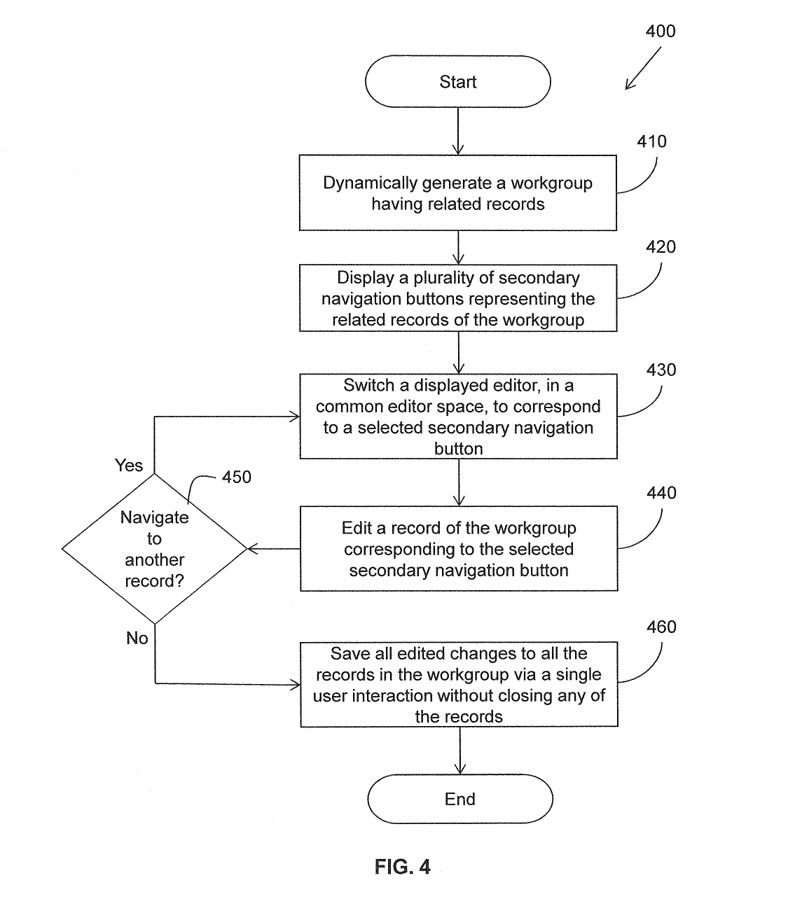

FIG. 4 illustrates one embodiment of a computer-implemented method 400, performed by the record management tool 111 of the computer system 100 of FIG. 1, for working with a plurality of related records. Method 400 is implemented to be performed by the record management tool 111 of FIG. 1, or by a computing device configured with an algorithm of the method 400. Method 400 will be described from the perspective that records stored in a database device 130 pre-exist in a related manner and can be accessed and edited using the record management tool 111 of the computer system 100 of FIG. 1.

Upon initiating method 400, at block 410, a workgroup is dynamically generated comprising a plurality of related records associated with a record management tool 111 running on a computing device 111. The workgroup is generated by opening the plurality of related records on a display screen 120 in response to user interaction with a graphical user interface associated with the record management tool 111. In one embodiment, the workgroup comprises a data structure within the computing device 111 that associates the plurality of related records. In this sense, the workgroup comprises the plurality of related records. By being associated in a workgroup, the records in the workgroup are eligible to be navigated between, edited, and saved in accordance with the corresponding functionality disclosed herein.

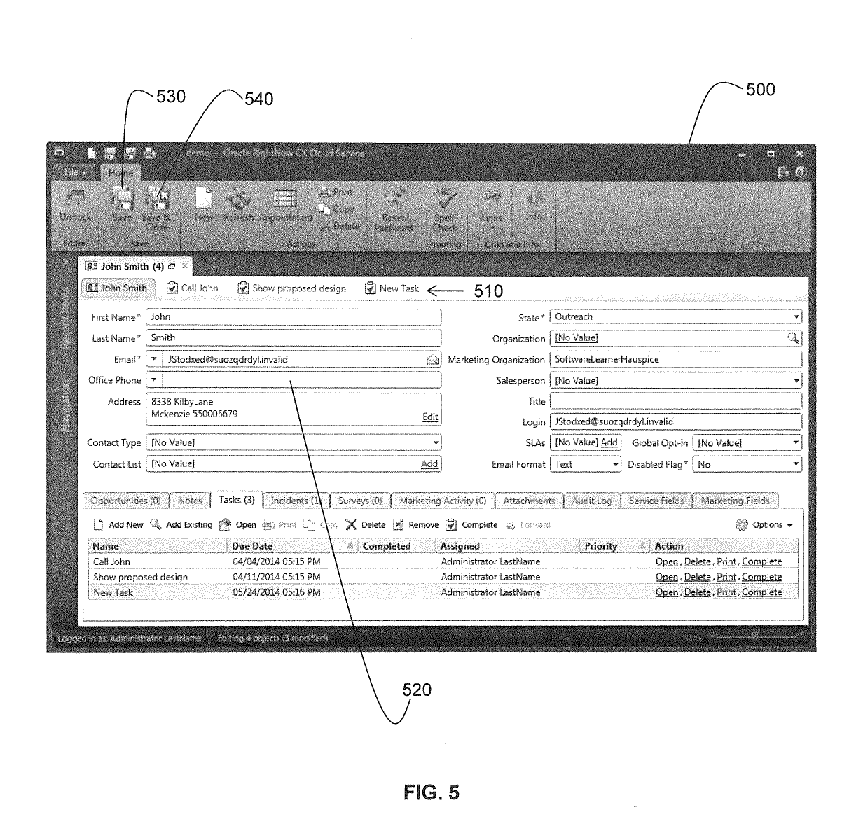

Continuing with the method 400, at block 420, a plurality of secondary navigation buttons are displayed proximate to each other via the graphical user interface in response to generating the workgroup (i.e., when the related records are opened). Each secondary navigation button is associated with and represents an opened record of the workgroup. For example, FIG. 5 illustrates one embodiment of a display view 500 of the graphical user interface showing a plurality of secondary navigation buttons 510 representative of opened related records in the workgroup.

It is noted here that a secondary navigation button associated with a related secondary record is displayed when that secondary record is opened. Furthermore, in accordance with one embodiment, additional records can be added to a workgroup (e.g., when adding a new task to an incident). The record types that can be automatically added to a workgroup upon opening of a record depends on the exact configuration of the system.

At block 430, a displayed editor, in a common editor space 240, is switched to correspond to a presently selected secondary navigation button and its associated record. The displayed editor switches in response to user navigation between the records of the workgroup via user selection of the secondary navigation buttons, without having to close any of the records of the workgroup.

At block 440, a record of the workgroup, corresponding to the presently selected secondary navigation button, is edited via its displayed editor in the common editor space 240. For example, referring to FIG. 5, a phone number may be entered in the address field 520 for the office phone. At block 450, a decision is made with respect to navigating to another record by selecting a corresponding secondary navigation button. If the decision is to navigate to another record, then the method 400 reverts back to block 430 where the displayed editor is switched in the common editor space 240. If the decision is not to navigate to another record, then the method 400 proceeds to block 460.

At block 460, all of the edited changes to all of the records of the workgroup are saved (e.g., to the database device 130) via a single user interaction with the graphical user interface, without having to close any records of the workgroup. For example, referring to FIG. 5, by clicking on the “save” icon 530, all edited changes in the editors of the records of the workgroup will be saved to the database device 130. Alternatively, by clicking on the “save and close” icon 540, all edited changes in the editors of the records of the workgroup will be saved to the database device 130 and all the records in the workgroup will be closed.

In this manner, a record management tool can provide efficient manipulation and updating of multiple records of information in a dynamically defined workgroup, instead of having to deal with multiple overlaid windows of records that have to be opened and closed multiple times. Even though examples of the method 400 are discussed herein with respect to a customer support center scenario, where complaints or questions submitted by customers in the form of incidents are handled, the method 400 may be implemented as part of any computer application for manipulating multiple records of information for any scenario.

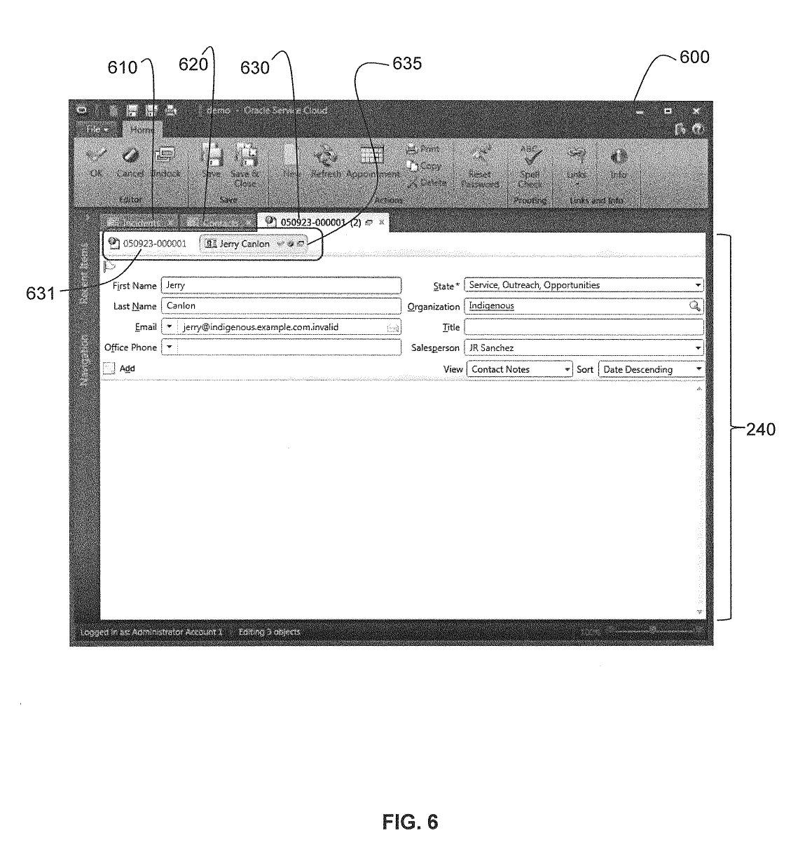

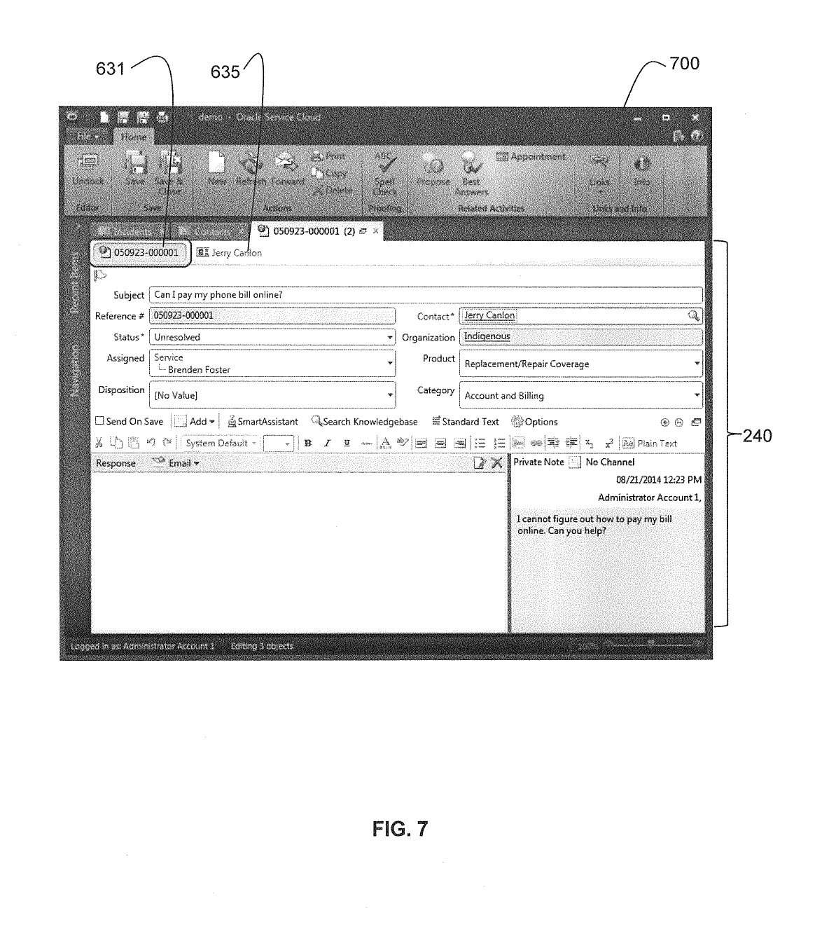

FIG. 6 and FIG. 7 illustrate another example of switching back and forth between related records in a workgroup. FIG. 6 illustrates one embodiment of a display view 600 of a graphical user interface provided by the record management tool 111 of the computer system 100 of FIG. 1. In the display view 600 of FIG. 6, tabs 610, 620, and 630 are shown which correspond to higher level records. The tab 610 corresponds to an incidents report, which lists incidents. The tab 620 corresponds to a contact report, which lists contacts in the computer system. The tab 630 corresponds to a specific incident record, which may have been opened from the incidents record corresponding to the tab 610.

Also shown in the display view 600 of FIG. 6 are secondary navigation buttons 631 and 635, respectively representing an incident record for the specific incident associated with the tab 630 and a related contact record for a contact (Jerry Canlon) of the specific incident. In FIG. 6, the secondary navigation button 635 for the related contact record is selected. As a result, the editor for the related contact record is displayed in the common editor space 240 for the specific incident.

If a user wants to navigate back to the record of the specific incident via the secondary navigation button 631, the user may do so without having to close the related contact record associated with the secondary navigation button 635. For example, FIG. 7 illustrates another embodiment of a display view 700 of a graphical user interface provided by the record management tool 111 of the computer system 100 of FIG. 1. After selecting the secondary navigation button 631 corresponding to the record for the specific incident, the common editor space 240 switches to displaying the editor for the specific incident as shown in FIG. 7.

By having a single common editor space 240 that is shared by all of the editors of the records in a workgroup, the display screen 120 does not get cluttered with separate windows for each record. Furthermore, records may be navigated between, edited, and subsequently saved without having to open and close individual records multiple times in, for example, an iterative manner.

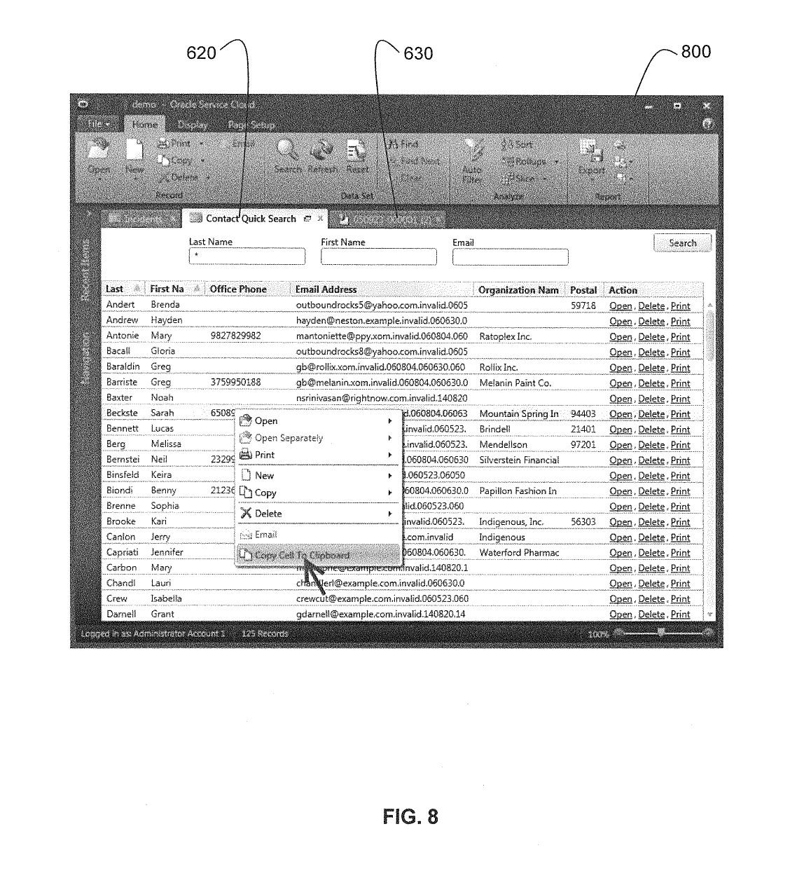

In one embodiment, other portions of a computer application (not in a current workgroup, e.g., a report) may be accessed while editing a related record of an incident. For example, FIG. 8 illustrates another embodiment of a display view 800 of a graphical user interface provided by the record management tool 111 of the computer system 100 of FIG. 1. Upon selecting the tab 620 corresponding to a contact report record, the graphical user interface displays a window of the contact report record as shown in FIG. 8.

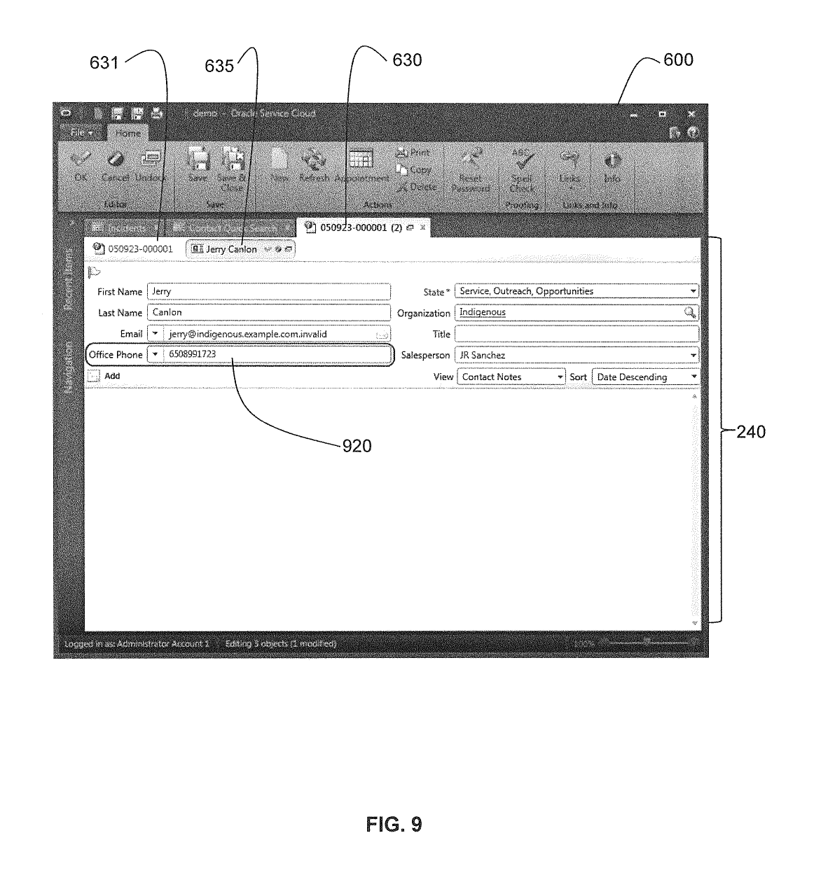

A user may select a cell in the window of the contact report record and copy the contents of the cell (e.g., a phone number) to a clipboard of the computing device 111 as shown in FIG. 8. The user may then navigate back to the contact record (for Jerry Canlon) of the workgroup of the specific incident via the incident tab 630 and the associated secondary navigation buttons 631 and 635. FIG. 9 illustrates an embodiment of a first updated view of the display view 600 of FIG. 6. Referring to FIG. 9, upon navigating back to the contact record, the user may paste the copied phone number into a field 920 of the editor of the contact record as shown in FIG. 9.

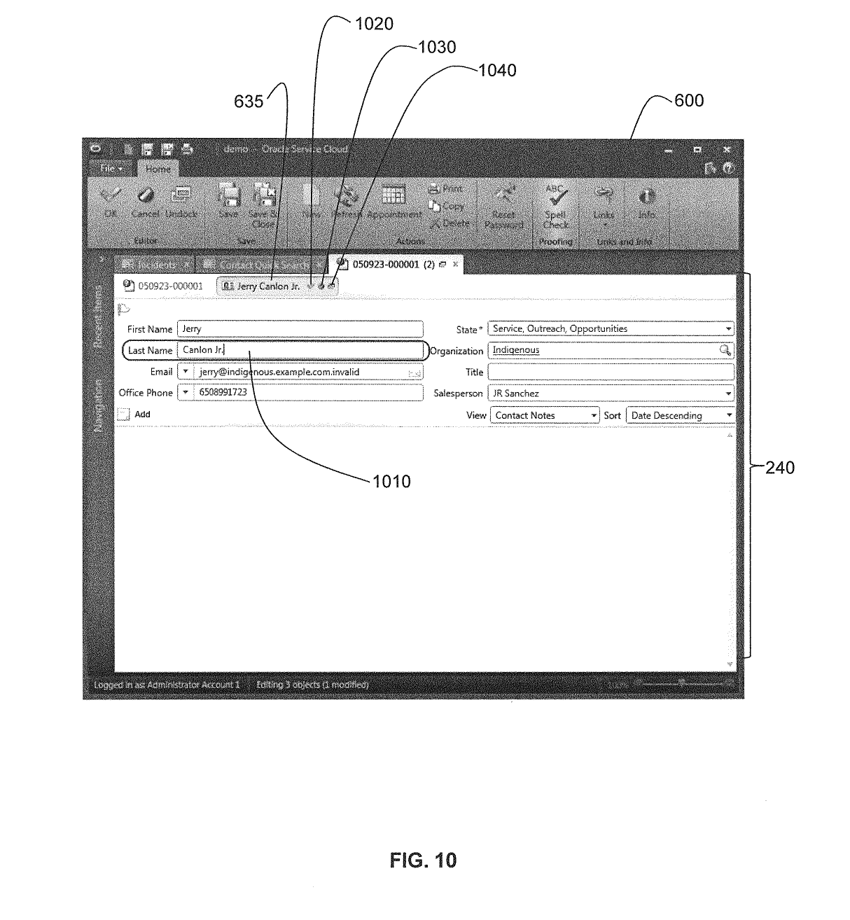

FIG. 10 illustrates an embodiment of a second updated view of the display view 600 of FIG. 6. Referring to FIG. 10, if the user notices that the customer name in the contact record is incorrect (e.g., left off “Jr.” as shown in FIG. 9), then the user may update the customer name in the contact name field 1010 of the contact record as shown in FIG. 10. Note that the change of the customer name is also reflected in the secondary navigation button 635 as shown in FIG. 10.

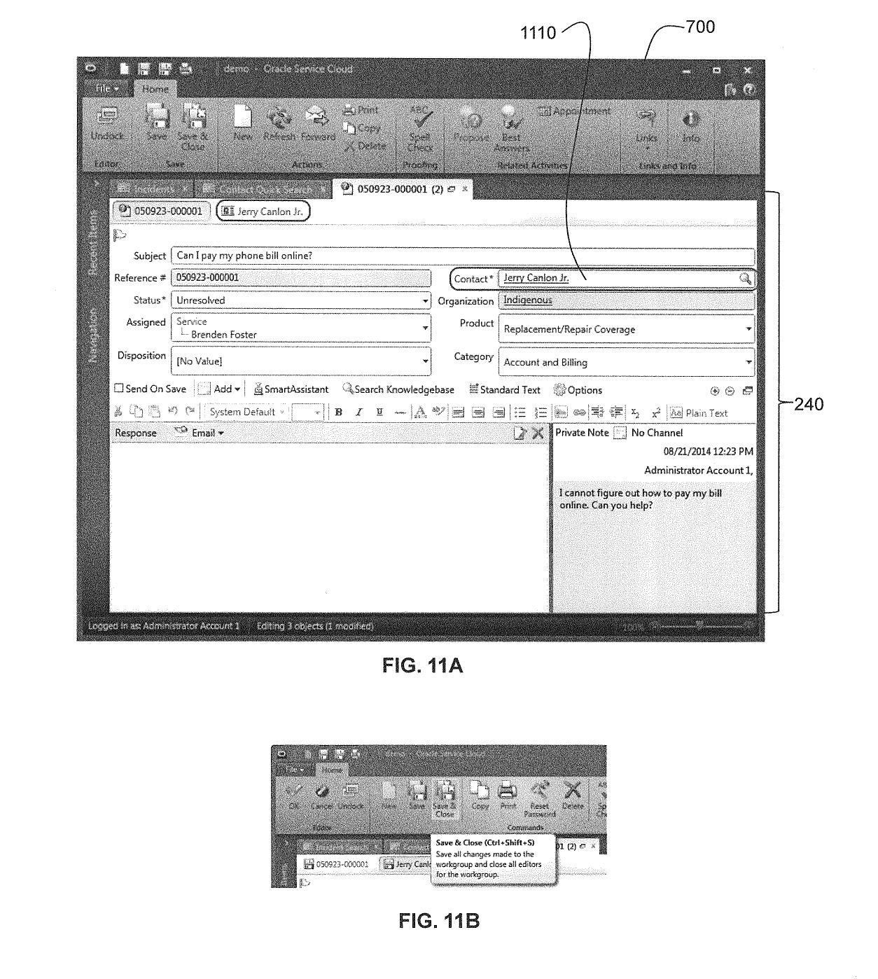

FIG. 11A illustrates an embodiment of an updated view of the display view 700 of FIG. 7. Referring to FIG. 11A, upon navigating back to the specific incident record via the secondary navigation button 631, it may be seen that the change in the customer name is reflected in the contact field 1110 as well, as shown in FIG. 11A.

In this manner, in accordance with one embodiment, even information from a record (e.g., a higher level record) outside of a workgroup may be accessed and used to edit other records that are within the workgroup. Again, the global saving logic 115 is configured to save all edited changes to the related records in a workgroup to the database device 130 in response to a single user interaction with the graphical user interface, as shown in FIG. 11B. FIG. 11B illustrates a portion of the embodiment of the display view of FIG. 10 associated with saving multiple related records via a single user interaction with a graphical user interface.

In accordance with one embodiment, each secondary navigation button may have one or more sub-buttons associated with it. For example, referring again to the embodiment of FIG. 10, the secondary navigation button 635 has three sub-buttons which include an “OK” sub-button 1020, a “Cancel” sub-button 1030, and an “Undock” sub-button 1040. When selected/activated by the user, the sub-buttons (as with the other selectable objects) are configured to cause the GUI to respond and perform various functions as programmed. For example, upon clicking the “OK” sub-button 1020, the interface causes all of the changes to the record associated with the secondary navigation button 635 to be accepted and saves the record to the workgroup (e.g., in a memory of the computing device 111) and the record is closed. The changes are not saved to the database device 130, however. Furthermore, if the editor associated with the record has required fields that are not filled in, the user may be prompted to fill in those required fields.

Upon clicking the “Cancel” sub-button 1030, the record is closed if no edited changes have been made to the record. If edited changes have been made to the record, the user may be asked whether or not the edited changes should be discarded before closing the record. Upon clicking the “Undock” sub-button 1040, the editor for the record associated with the secondary navigation button is undocked from the common editor space into a new window. This can be useful when it is desired to view multiple records side-by-side. Upon undocking, a “dock-to-editor” sub-button may be provided, allowing the editor of the record to be docked back to the common editor space of the workgroup.

In accordance with one embodiment, the ability to minimize a displayed view of a record (of a plurality of related records in a workgroup) is provided. The graphical user interface may provide a button icon associated with a record that may be selected to minimize the record. Upon minimizing a record, any edited changes to the record are held in a memory of the computing device.

The edited changes are not saved to the database device 130 as part of the minimizing function. Furthermore, the record may be un-minimized by selecting a displayed icon representing the minimized record. As such, the combinations of tabs, secondary navigation buttons, and sub-buttons (and their logical relationships) may be configured in accordance with various embodiments to provide easy and efficient manipulation of records in a workgroup. In accordance with one embodiment, a record of a workgroup cannot be minimized until that record has been undocked into a new window as discussed above herein.

Embodiments of a record management tool have been disclosed herein that dynamically generate workgroups of related records and allow easy and efficient navigation between the records in a workgroup via secondary navigation buttons provided as part of a graphical user interface. A single common editor space is provided for the workgroup by the graphical user interface, avoiding the use of multiple overlaid windows. In response to user navigation between the records of a workgroup, a displayed editor may be switched in the single common editor space. The displayed editor corresponds to a presently selected secondary navigation button and associated record of the workgroup.

Navigating between records and switching between editors may be accomplished easily and efficiently without having to close any of the records of the workgroup, and without having to perform a burdensome number of user actions. Furthermore, editing and saving of the records in a workgroup may also be accomplished easily and efficiently without having to close any of the records of the workgroup, perform a burdensome number of user actions, or separately save edits to individual records of the workgroup.

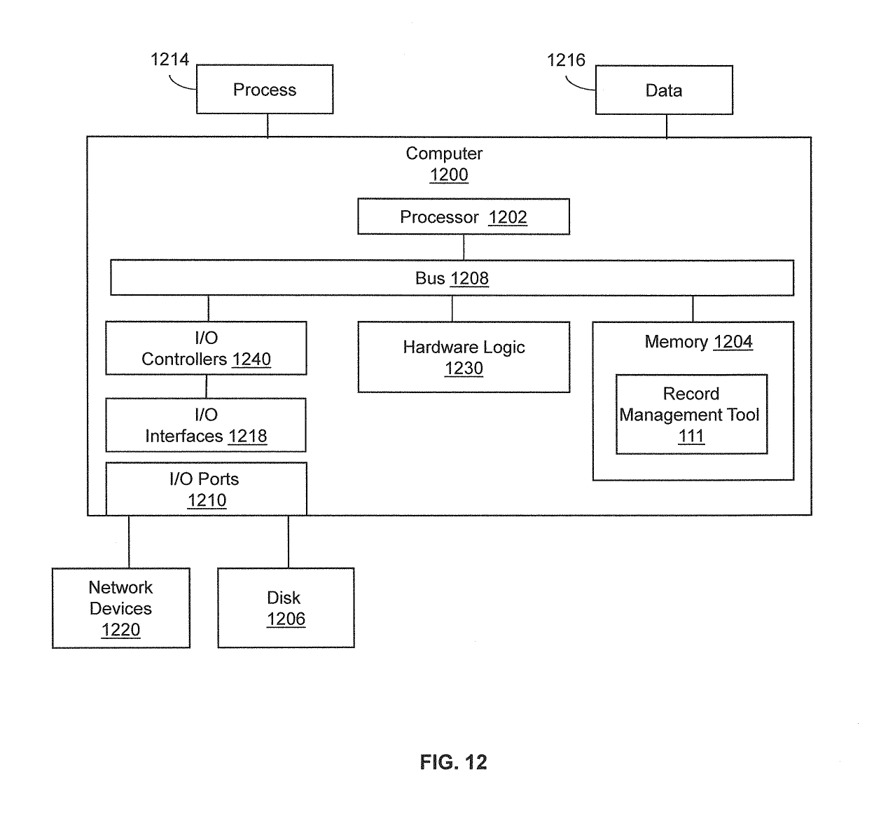

FIG. 12 illustrates one example embodiment of a computing device upon which the record management tool 111 may be implemented. The example computing device may be a computer 1200 that includes a processor 1202, a memory 1204, and input/output ports 1210 operably connected by a bus 1208. In one example, the computer 1200 may include the record management tool 111 configured to dynamically generate a workgroup of a plurality of related records associated with a computer application running on the computer 1200, allowing for the efficient management (navigation, editing, saving, etc.) of the records in the workgroup.

In accordance with one embodiment, the record management tool 111 is configured as computer-readable instructions (as an algorithm) stored in the memory 1204 which may communicate to the bus 1208 such that the processor 1202 may read in and execute the instructions. However, it is to be understood that, in different embodiments, the record management tool 111 may be implemented in hardware (e.g., as hardware logic 1230 connected to the bus 1208), a non-transitory computer-readable medium with stored instructions, firmware, and/or combinations of both.

In one embodiment, the record management tool 111 or the computer 1200 may be a structure (e.g., hardware, non-transitory computer-readable medium, firmware) for efficiently managing a plurality of related records in a workgroup.

The structure may be implemented, for example, as an ASIC or microprocessor. The ASIC or microprocessor may be programmed to dynamically generate a workgroup of related records, display a plurality of secondary navigation buttons associated with the related records, and allow switching between editors associated with the related records in a common editor space via the secondary navigation buttons. The structure may also be implemented as stored computer executable instructions that are presented to computer 1200 as data 1216 in the form of data structures that are temporarily stored in memory 1204 and then executed by processor 1202.

Generally describing an example configuration of the computer 1200, the processor 1202 may be a variety of various processors including dual microprocessor and other multi-processor architectures. A memory 1204 may include volatile memory and/or non-volatile memory. Non-volatile memory may include, for example, ROM, PROM, and so on. Volatile memory may include, for example, RAM, SRAM, DRAM, and so on.

A storage disk 1206 may be operably connected to the computer 1200 via, for example, an input/output interface (e.g., card, device) 1218 and an input/output port 1210. The disk 1206 may be, for example, a magnetic disk drive, a solid state disk drive, a floppy disk drive, a tape drive, a Zip drive, a flash memory card, a memory stick, and so on. Furthermore, the disk 1206 may be a CD-ROM drive, a CD-R drive, a CD-RW drive, a DVD ROM, and so on. The memory 1204 can store a process 1214 and/or a data 1216, for example. The disk 1206 and/or the memory 1204 can store an operating system that controls and allocates resources of the computer 1200.

The computer 1200 may interact with input/output devices via the i/o interfaces 1218 and the input/output ports 1210. Input/output devices may be, for example, a keyboard, a microphone, a pointing and selection device, cameras, video cards, displays, the disk 1206, the network devices 1220, and so on. The input/output ports 1210 may include, for example, serial ports, parallel ports, and USB ports.

The computer 1200 can operate in a network environment and thus may be connected to the network devices 1220 via the I/O interfaces 1218, and/or the I/O ports 1210. Through the network devices 1220, the computer 1200 may interact with a network. Through the network, the computer 1200 may be logically connected to remote computers. Networks with which the computer 1200 may interact include, but are not limited to, a LAN, a WAN, and other networks.

Definitions and Other Embodiments

In another embodiment, the described methods and/or their equivalents may be implemented with computer executable instructions. Thus, in one embodiment, a non-transitory computer storage medium is configured with stored computer executable instructions configured as an algorithm that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional actions that are not illustrated in blocks. The methods described herein are limited to statutory subject matter under 35 U.S.C §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

LAN: local area network.

RAM: random access memory.

DRAM: dynamic RAM.

SRAM: synchronous RAM.

ROM: read only memory.

PROM: programmable ROM.

USB: universal serial bus.

WAN: wide area network.

“Computer-readable medium”, as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, and other media from which a computer, a processor or other electronic device can function with. Each type of media, if selected for implementation in one embodiment, includes stored instructions of an algorithm configured to perform one or more of the disclosed and/or claimed functions. For example, a non-transitory computer-readable medium may store computer-executable instructions that are part of an algorithm that, when executed by a computer, cause the computer to perform a method, the instructions comprising instructions configured for performing one or more disclosed and/or claimed functions. Computer-readable media described herein are limited to statutory subject matter under 35 U.S.C §101.

“Logic”, as used herein, represents a component that is implemented with computer or electrical hardware, firmware, a non-transitory medium with stored instructions, and/or combinations of these to perform any of the functions or actions as disclosed herein, and/or to cause a function or action from another logic, method, and/or system to be performed as disclosed herein. Logic may include a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions.

Logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. Logic is limited to statutory subject matter under 35 U.S.C. §101.

A “data structure”, as used herein, is an organization of data in a computer where the organization of the data is such that the data can be used efficiently. A data structure may be any one of, for example, a data file, a data array, a data record, a data table, a graph, or a tree. Other examples of data structures are possible as well, in accordance with other embodiments.

“User”, as used herein, includes but is not limited to one or more persons, computers or other devices, or combinations of these.

“Record”, as used herein, is a data structure having fields that contain data.

“Graphical user interface logic, as used herein, is a type of interface logic that allows users to interact with electronic devices through displayed graphical elements of a graphical user interface. The actions in a graphical user interface logic are usually performed through direct manipulation of the graphical elements.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this disclosure is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A computer-implemented method comprising:
dynamically generating a workgroup comprising a plurality of related records associated with a computer application running on a computing device, wherein generating the workgroup includes opening the plurality of related records on a display screen in response to user interaction with a graphical user interface associated with the computer application;
displaying a plurality of secondary navigation buttons proximate each other via the graphical user interface in response to generating the workgroup, wherein each secondary navigation button is associated with a record of the workgroup; and
in response to user navigation between records of the workgroup via user selection of the secondary navigation buttons via the graphical user interface, switching a displayed editor, in a common editor space provided by the graphical user interface, to correspond to a presently selected secondary navigation button and associated record without having to close other records of the workgroup.

2. The computer-implemented method of claim 1, further comprising editing each record of the workgroup, using a corresponding displayed editor for each record of the workgroup in the common editor space, upon user navigation to each record of the workgroup without having to close the other records of the workgroup.

3. The computer-implemented method of claim 2, further comprising saving all edited changes to the plurality of related records in the workgroup to a database device in response to a single user interaction with the graphical user interface, without having to close any records of the workgroup.

4. The computer-implemented method of claim 1, wherein the plurality of related records of the workgroup comprise a primary record, having information for an incident reported by a customer, and at least one related secondary record.

5. The computer-implemented method of claim 1, wherein the plurality of related records of the workgroup comprise at least one related secondary record comprising customer support information associated with one of a contact, an organization, a task, an opportunity, and an organization.

6. The computer-implemented method of claim 1, further comprising:
(i) copying first information from a first record of the plurality of related records of the workgroup to a clipboard of the computing device in response to user interaction with the graphical user interface;
(ii) navigating to a second record of the plurality of related records of the workgroup, without closing the first record, via selection of a secondary navigation button associated with the second record in response to user interaction with the graphical user interface; and
(iii) pasting the first information from the clipboard into the second record in response to user interaction with the graphical user interface.

7. The computer-implemented method of claim 1, further comprising minimizing a displayed view of one record of the plurality of related records in response to user interaction with the graphical user interface, wherein the minimizing results in holding any edited changes to the one record in a memory of the computing device instead of saving the any edited changes to a database device.

8. The computer-implemented method of claim 1, further comprising accepting any edited changes to only one record of the plurality of related records in response to user interaction with the graphical user interface via a displayed sub-button associated with a secondary navigation button of the one record.

9. The computer-implemented method of claim 1, further comprising canceling any edited changes to only one record of the plurality of related records in response to user interaction with the graphical user interface via a displayed sub-button associated with a secondary navigation button of the one record.

10. A computing system, comprising:
a display screen;
graphical user interface logic configured to:
(i) provide a graphical user interface associated with a computer application,
(ii) facilitate the opening of records associated with the computer application on the display screen in response to user interaction with the graphical user interface, and
(iii) facilitate the displaying, on the display screen, of secondary navigation buttons associated with the records upon opening of the records via the graphical user interface; and
workgroup logic configured to:
(i) dynamically generate a workgroup, comprising a plurality of related records associated with the computer application, in response to the graphical user interface logic opening the plurality of related records in response to user interaction with the graphical user interface,
(ii) allow user navigation between the plurality of related records of the workgroup via user selection of the secondary navigation buttons,
(iii) switch a displayed editor, in a common editor space provided by the graphical user interface logic, to correspond to a presently selected secondary navigation button and associated record.

11. The computing system of claim 10, further comprising record editing logic configured to provide an editor for each related record of the plurality of related records to facilitate editing of the plurality of related records in the common editor space.

12. The computing system of claim 10, further comprising global saving logic configured to save all edited changes to the plurality of related records in the workgroup in response to a single user interaction with the graphical user interface.

13. The computing system of claim 12, further comprising a database device configured to store the records associated with the computer application, wherein the global saving logic is configured to save the edited changes to the plurality of related records to the database device.

14. The computing system of claim 10, wherein the display screen facilitates user interaction with the graphical user interface.

15. A non-transitory computer-readable medium storing computer-executable instructions that are part of an algorithm that, when executed by a computer, cause the computer to perform a method, wherein the instructions comprise instructions configured for:
opening a plurality of related records in response to user interaction with a graphical user interface, wherein each record of the plurality of related records is implemented as a data structure;
displaying representations of the plurality of related records as secondary navigation buttons on a display screen via the graphical user interface in response to opening the plurality of related records;
generating a workgroup, comprising the plurality of related records, in response to opening the plurality of related records; and
facilitating user navigation between the plurality of related records of the workgroup via user selection of the secondary navigation buttons via the graphical user interface, wherein the user navigation results in switching a displayed editor, in a single common editor space displayed on the display screen, to correspond to a presently selected secondary navigation button and associated record.

16. The non-transitory computer-readable medium of claim 15, wherein the instructions further comprise instructions configured for editing each record of the workgroup, using a corresponding displayed editor for each record of the workgroup in the common editor space, upon user navigation to each record of the workgroup without having to close any of the records of the workgroup.

17. The non-transitory computer-readable medium of claim 15, wherein the instructions further comprise instructions configured for saving all edited changes to the records in the workgroup to a database device in response to a single user interaction with the graphical user interface, without having to close any records of the workgroup.

18. The non-transitory computer-readable medium of claim 15, wherein the instructions further comprise instructions configured for minimizing a displayed view of a record of the workgroup in response to user interaction with the graphical user interface, wherein the minimizing results in holding any edited changes to the record of the workgroup in a memory of the computing device instead of saving the any edited changes to a database device.

19. The non-transitory computer-readable medium of claim 15, wherein the instructions further comprise instructions configured for accepting any edited changes to only one record of the workgroup in response to user interaction with the graphical user interface via a displayed sub-button associated with a secondary navigation button of the one record.

20. The non-transitory computer-readable medium of claim 15, wherein the instructions further comprise instructions configured for undocking an editor of a record of the workgroup from the common editor space to a new window provided by the graphical user interface in response to user interaction with the graphical user interface via a displayed sub-button associated with a secondary navigation button of the record.
